(19) United States
(12) Patent Application Publication
(10) Pub. No.: US 2003/0182410 A1
(43) Pub. Date: Sep. 25, 2003

(54) Method and apparatus for determination of optimum path routing

(76) Inventors: Sapna Balan, San Jose, CA (US); Thomas Normile, Palo Alto, CA (US); Stacy W. Smith, Evergreen, CO (US)

Correspondence Address: Pennie & Edmonds, LLP, 3300 Hillview Avenue, Palo Alto, CA, 94304, US

(21) Appl. No.: 10/105,677

(22) Filed: Mar. 20, 2002

(51) Int. Cl. G06F 15/173

(52) U.S. Cl. 709/223

(57) ABSTRACT

The method and apparatus of the present invention provide for selection of the optimum mirror site server for a particular client request preferably using anycast IP addressing. Additionally, network performance data such as data pipe load, server load and server configuration are considered to ensure that each communication transaction is completed using the best performance available at the time of the client request.

### FIELD OF THE INVENTION

The present invention relates to data communications, and more particularly to a method and apparatus for selecting the optimum server from among mirrored content servers for responding to a particular client request.

### BACKGROUND OF THE INVENTION

As the use of networks increases, more and more users are turning to network service providers for hosted data services. Common to all network structures is the notion of sending and receiving. Generally, a client is the source of a request for some service and a server provides that service, but during a communications session both will act as both sender and receiver. Also common to all networks is the notion of addressing. Addressing involves designating data terminals and sending and receiving data to data terminals individually so that the source and sink for the communication can be specifically identified. Note that for purposes of this discussion, a data terminal is considered to be a device having data processing, display and input/output capability. Thus a data terminal could be any number of physical machines including a desktop PC, a laptop PC, a router, or any other device capable of communicating with other such devices.

At the present time there are numerous addressing schemes in use. Each of these schemes fits one of three general categories: unicast, multicast or anycast. In a unicast addressing scheme, a communication session occurs between a single sender and a single receiver, each having a unique IP address. Multicast addressing enables a single sender to send to multiple receivers, where, as with unicast, each of the multiple receivers has a unique IP address. In this scheme the sender has the ability to transmit to a group of receiver addresses. Anycast addressing, like multicast addressing, allows a single sender to send to multiple receivers. However, unlike multicast addressing, anycast addressing assigns the same public address to all receivers and, additionally, has the ability to determine which of the multiple receivers sharing the same address is the closest, in hops, to the sender. Hops occur since the sender and receiver may be on different networks and must therefore be linked together. Each link is a leg of the communication, or a hop. The fewer the number of hops, the more efficient the communication.

All of the above addressing methods generally utilize either DNS (Domaine Name Server) addresses or static IP (Internet Protocol) addresses. Each of these types of addresses assigns a unique number to a data terminal device. The DNS method uses a text-based name that is converted, or resolved, to a unique IP address via a DNS look-up table. The static IP method uses a fixed number that does not need to be resolved. With both, one common feature is that for the duration of the communication session both the sender and the receiver have unique IP address numbers that are not shared by any other data terminal device.

One contemporary network addressing scheme uses IPv4, a 32 bit, single device per address method. In operation, a client sends a request for service to an ISP. A DNS lookup is done which translates the text address request into an IP address. For example, a client might send a request via a browser to www.TourdeFrance.com in order to check on the progress of the race. A DNS, for example, at the client's ISP, does a lookup and resolves the text address to a 32 bit IPv4 address, for example, 228.128.10.8. The DNS then returns this IP address to the client. At the client side an HTTP GET to the resolved IP address is issued and the client's device is connected in a manner well known to those of skill in the art.

The demand for certain data, for example, a video feed of a sporting event, can be so large that more than one data server with identical data may be required to satisfy the demand. Typically, a network hosting service will supply these multiple data servers in different geographical parts of the world. These identical servers are referred to as data mirrors, or mirror sites. Mirror sites are used for a number of reasons, including data redundancy, traffic demand, and cost control.

A problem may arise when a specific mirror site experiences an excessive number of data requests. As an example, there may be three mirror sites that all contain the same data; one located in Paris, one in New York, and one in San Francisco. A routing scheme must be provided to direct a client request to a particular content server. In one scheme, each of these servers will have a unique address. The decision regarding which one of the servers to be connected to the client resides with the DNS. Using a routing table, the DNS is configured to return one of the three unique addresses to the client. But there are no guarantees that the address sent will be the most efficient. Thus, one of two things will happen: either the clients will experience a delay in the delivery of the data or, the data will be delivered in a very inefficient way. In another scheme, using anycast addressing, multiple servers will have the same anycast address and the server presenting the least hops to the requester will be returned. Various dynamic schemes also have been proposed wherein an address resolver determines a “best” server to fill the client request. However, various disadvantages exist with current schemes such that an optimum connection/route is still not made, and also in that network administrators may not have sufficient control over routing decisions in specific circumstances.

### SUMMARY OF THE INVENTION

The method and apparatus of the present invention provide for selection of the optimum mirror site server for a particular client request preferably using anycast IP addressing. The method factors in certain network performance data such as data pipe load, server load and server configuration to ensure that each communication transaction is completed using the best performance available at the time of the client request.

In one preferred embodiment the present invention provides optimum connection between a client and a server using the least hops path, taking into account network conditions. This is accomplished through use of a Client Request Handler (CRH) that resides between the edge of the network and one of a plurality of mirror site data servers each having an identical network address. A client requests a communication session in the conventional manner, e.g. instructing a browser to access a site. The request is received by the client's ISP and a DNS lookup performed. The DNS resolves the request and is configured in such a way as to return the anycast address of the multiple mirror sites to the client. The client then sends an HTTP GET to the host of the anycast address on port 80, which is a standard default port. The CRH, monitoring port 80, receives the HTTP GET and requests a best path lookup using the Best Server Locator (BSL). The BSL returns the actual IP address of the best server to the CRH based upon periodically updated metrics from the network and the servers. The CRH then returns the best path IP address to the client via an HTTP 301 or 302 message. The client then connects to the best path IP address in the conventional manner.

The present invention also improves overall system performance by choosing a best path only after including system performance parameters. To accomplish this, the BSL is periodically updated with data about server loading, data pipe congestion, and server configuration for each of the mirror sites in the BSL. By so updating, the method of the present invention is able to adjust dynamically to network conditions such as peak request periods and scheduled server downtime enabling the optimum performance path to a mirror server to selected for any given remote client request. These and other benefits and advantages of the present invention are discussed in detail in conjunction with the drawings and figures below.

### BRIEF DESCRIPTION OF THE DRAWINGS

FIG. 1 is a high-level block diagram of a system that can make use of a first embodiment of the method of the present invention;

FIG. 2A is a flow chart of the method of the present invention;

FIG. 2B is a state diagram schematically illustrating a best server determination step according to a preferred embodiment of the invention; and

FIG. 3 is a flow chart of an error handling routine contained in a method of the present invention.

### DETAILED DESCRIPTION OF PREFERRED EMBODIMENTS

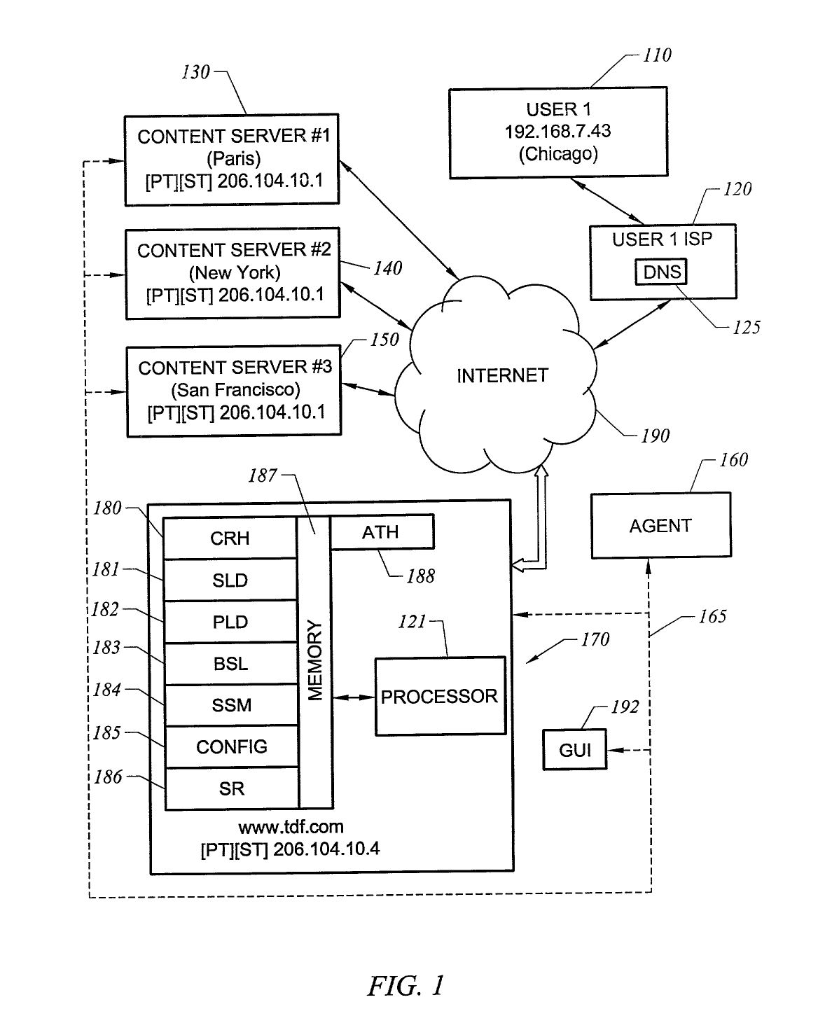

Referring to FIG. 1, an exemplary embodiment of the present invention is illustrated. A User 110, for example in Chicago, wishes to access data provided by www.TDF.com. The User's remote client device connects to the Internet 190 in the customary manner through ISP 120. ISP 120 contains the conventional hardware and software necessary for connection to the Internet, including DNS 125. Note that the terms “client” and “server” are used in a network topology sense. That is, where a device is the source of a request for data it is referred to as a client, whereas the device that sends the data in response to the request is referred to as a server.

Also connected to the Internet 190 in the customary manner are Content Server #1 130, Content Server #2 140, Content Server #3 150, and Routing Manager 170. Preferably, these components are also connected and communicate directly with one another over Proprietary Network 165, which also preferably includes Agent 160 and a graphical user interface, GUI 192. Network 165 additionally includes routers and other hardware and software components (not shown) as are conventional in a communication network such as a TCP/IP-based network.

The content servers are mirror sites of the same content provider and, preferably together with Routing Manager 170, form an anycast group. Such content servers are typically geographically disbursed, for example content Server #1 130 may be located in Paris, while Content Server #2 140 may be in New York and Content Server #3 150 may reside in San Francisco.

Routing Manager 170 generally includes Processor 121 and Memory 187. If desired, Routing Manager 170 may alternatively and additionally function as an ISP, in which case conventional hardware and software necessary for that function, including a DNS, may be included. Contained within the Memory 187 are Client Request Handler module (CRH) 180, Server Load Detector module (SLD) 181, Pipe Load Detector module (PLD) 182, Best Server Locator module (BSL) 183, Server Status Monitor module (SSM) 184, Configurator module 185, Static Redirector module (SR) 186, and Administrative Thread Handler module (ATH) 188. Not shown, but well understood to those of skill in the art, are other customary components needed to operate a data management system such as power sources, data trunks and buses, etc. The absence of these normal devices should not be read as a limitation on the method of the invention.

The operation of the BSL 183 and CRH 180 are explained in detail below. However, briefly stated, the function of the CRH is to monitor appropriate port(s), such as port 80, for client requests and handle client based communications between the port and BSL 183. The BSL determines the best server to respond to a client request based on network metrics as provided through data structures updated by SLD 181, PLD 182 and SSM 184.

The function of the SLD 181 is to track the activity of all the mirror sites. The function of the PLD 182 is the same as the SLD 181, except that it tracks activity within data pipes in the network. SSM 184 maintains the status of each of the mirror sites, for example, whether or not the site is on line. These memory modules are periodically updated by Agent 160. Agent 160 continuously monitors the network, for example using SNMP queries to determine load on content servers by checking TCP connections and the level of in/out octets at network routers, and using HTTP GET to obtain the status of mirror site servers. Agent 160 is preferably programmed with upper and lower limits, or other triggering criteria, for each network parameter such that non-conforming parametric values are reported to the associated module of Routing Manager 170. The SLD, PLD and SSM modules in turn update the appropriate data structures read by BSL 183.

ATH 188 handles communications within Network 165, for example between Routing Manager 170, and Agent 160 and GUI 192. GUI 192 is typically accessed by system administrators for administrative functions such as monitoring, maintenance and manual reconfigurations and resets. ATH 188 also handles the error reporting routine to write error messages to an error log that may be accessed by system administrators through GUI 192 as explained below. Configurator module 185 maintains and updates configuration files for Routing Manager 170 and reads and loads configuration files into the data structure as is known in the art. Static Redirector (SR) 186 may be configured by system administrators to override a best server determination with a static default server. Typically such a static redirect would be implemented by a system administrator in response to anomalous network conditions, but may be done for any reason.

In a preferred embodiment, all three of the mirror sites and Routing Manager 170 have the same published anycast address, thus forming an anycast group. However, each mirrored content server has a unique physical or specific IP address that is not published and is known only to the network. Thus, in response to a user requesting www.TFD.com, the user's ISP DNS will return the IP address for Routing Manager 170, for example (PT)(ST)(206.104.10.4). In this IPv6 example, (PT) is a 32 bit value identifying the public topology of the address, (ST) is a 24 bit value identifying the specific site topology, and the balance of the address is a 32 bit value identifying a specific server with the site topology. It should also be noted that while the method of the present invention is described using IPv6 anycast address structures, any form of IP addressing, including for example, conventional IPv4 addressing, may be used without departing from the spirit of the invention.

In general, to receive data from a content provider, User 1 110 sends a request to User 1 ISP 120 in the conventional manner. DNS 125 does a lookup, and returns the address of a content server to the client device. However, with the present invention, the address returned will be that of Routing Manager 170. The client device will request connection to the returned address, but advantageously unlike the current art, in the case of the present invention, Routing Manager 170 will return a best server using the unique functionality of BSL 183. As further detailed below, Routing Manager 170 contains the necessary intelligence in the form of software code to dynamically determine which of the three content servers, all with the same anycast address, is the best for the incoming request from User 1 110.

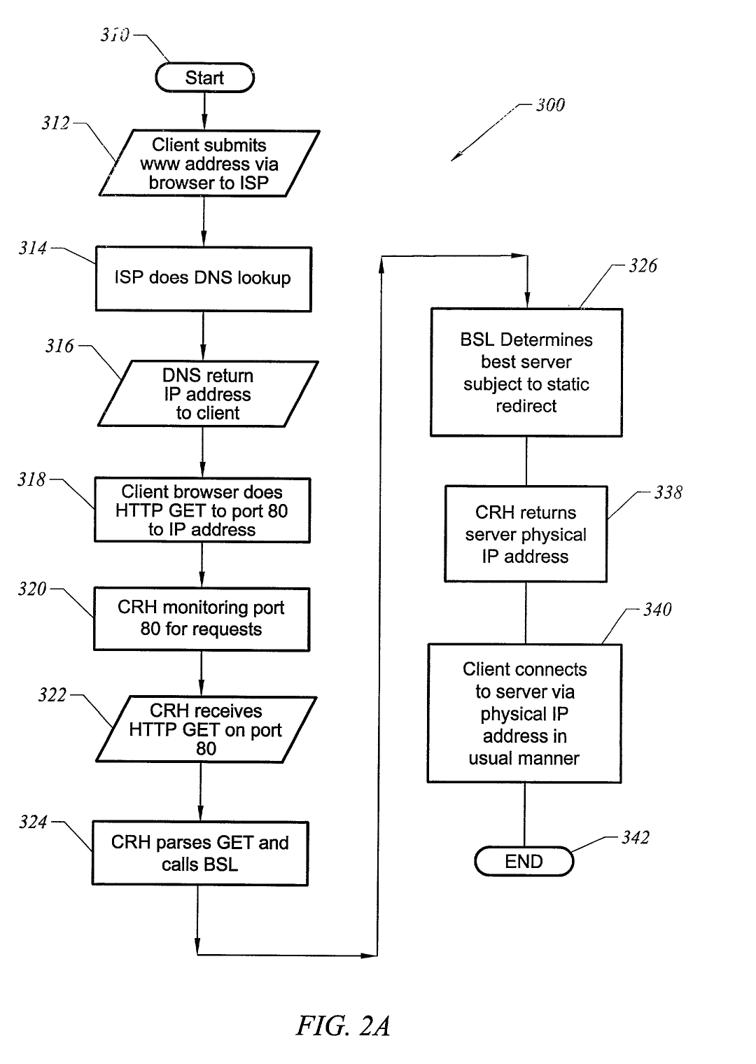

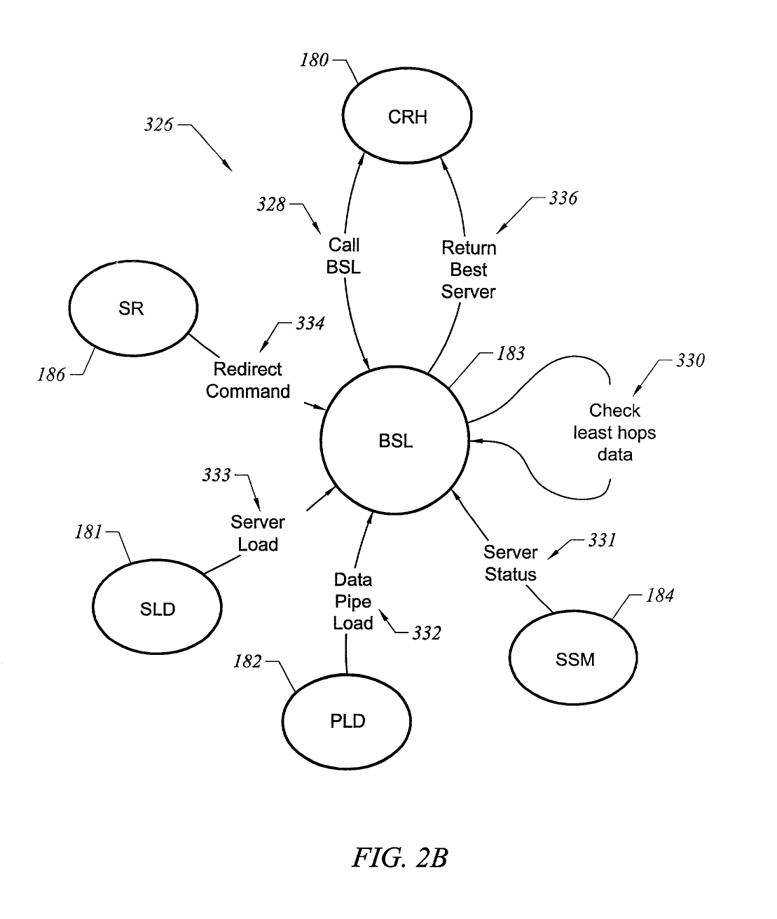

Referring now to FIG. 2A, a process flow 300 of a preferred embodiment of the method of the present invention is shown. The process begins at step 310. For purposes of this detailed discussion, it is assumed that at step 310 the various systems that combine to form the communications network are all properly operating and in a state capable of receiving and responding to client requests. At step 312 a client, for example, User 1 110 in FIG. 1, submits a request via a browser to an ISP, for example, User 1 ISP 120 of FIG. 1. The request may be submitted in one of a number of customary fashions, for example, as a DNS request in the form of www.TFD.com as known in the art. At step 314 the ISP does a DNS lookup on the domain name server and, at step 316, the address of Routing Manager 170 is returned to the client device.

At this point the client browser issues an HTTP GET at step 318 to the address returned by the DNS. CRH 180 monitors port 80 of the Routing Manager for incoming address requests at step 320. Next, at step 322, the CRH receives the HTTP GET command and then at step 324 parses the HTTP GET command and calls the IP address of the best mirror site for the remote client request from the BSL, for example, BSL 183 of FIG. 1.

At step 326, the BSL determines the best server for the client request, subject to any static redirect command as explained in detail below, and returns the physical or specific IP address of the determined best mirror site. At step 338, CRH 180 returns the determined IP address via an HTTP 301 or 302 command to the client/user 1 110. Thereafter, in step 340, the client connects to the selected best mirror site using the returned specific IP address via a conventional Internet connection. Processing in Routing Manager 170 ends at 342 until a new server request is received.

In step 326, in order to efficiently select the best server, numerous processing steps occur rapidly and essentially simultaneously. For example, one function of BSL 183 is to maintain a cross-referenced, least-hops list of mirror sites, including the physical or specific addresses of each of the mirror sites assigned the anycast address submitted by the client via CRH 180. In one preferred embodiment, the physical addresses are unicast addresses. Thus for a given address request, the BSL 183 may initially return the physical address of a least-hops mirror site for that request.

However, least hops is just one parameter considered by BSL 183. The data structure read by BSL 183 is, as explained above, continually updated with metrics, including server loading, data pipe congestion, and server status, related to the performance of the network. Thus, these parameters from Server Load Detector 181, Pipe Load Detector 182 and Server Status Monitor 184 are constantly used by BSL 183 to determine which of the mirror site servers are best for a given remote client request based upon the IP address of the request. As network conditions change, the BSL 183 in cooperation with the CRH 180 will thus be able to select the optimum path for any given remote client request.

The functionality of BSL 183 as occurring in step 326 is illustrated diagrammatically in FIG. 2B. When CRH 180 calls BSL 183 at 328, a number of simultaneous events occur. The BSL checks its least hops data at 330. This check occurs repeatedly until the best server is returned at 336. The BSL receives server status at 331 from SSM 184, pipe load data at 332 from PLD 182 and server load data at 333 from SLD 181. To determine the best server each of the parameters are evaluated according to a predetermined control logic, which may be set and updated by a system administrator through GUI 192.

By way of example, the control logic may set specific values as threshold values for one or more parameters. For example, least hops may be set as a maximum number of hops, server load may be set at varying maximum values corresponding to a maximum number of hits at a server beyond which further requests will be directed to a different server, or pipe load may be set such that the number of packets or bytes in and out of a network router does not exceed a maximum. As a further example, the BSL may be set to default to the least hops server provided that maximum threshold values for the other parameters are not exceeded for the least hops server. In the event that a threshold value is exceeded, the BSL compares the next least hops server to the threshold values and so on until an acceptable server is identified. In an alternative embodiment, the BSL is set to default to the lowest load server subject to a threshold value of maximum hops. If the threshold hops between the client and default server is exceeded, the BSL selects the next lowest load server and so on until an acceptable server is identified.

SLD 181, PLD 182 and SSM 184 also include error detection functionality based the network queries reported thereto. Each module contains information on network errors that may be encountered. Preferably, the different error types are classified as insignificant or informational only, minor, major or critical. When an error is encountered, the module determines how to handle the error based on its classification. For example, a critical error will typically cause the module to inform the BSL that the server or pipe involved is unavailable, whereas insignificant errors may be simply counted, and escalated in classification if persistently reoccurring. Once the error has been resolved, the BSL 183 is again updated and the associated server will again appear as a possible best route choice. As explained below, errors are also reported to the Error Handling Routine of ATH 188 for notification to the administrator as appropriate. Module 190 is described further below.

In the event that a system administrator determines a particular server or servers should not be returned for some reason, the administrator may enter a static redirect command through GUI 192. The redirect command 334 is transferred to the BSL through SR 186 and overrides any best server determination by redirecting the request according to the static redirect hierarchy entered by the administrator. While not specifically illustrated in FIG. 2B, in a further alternative preferred embodiment of the invention, additional non-system performance parameters, such as time of day restrictions or client status, may be entered by the administrator by modifying the data structures read by the BSL and utilized in the best server determination.

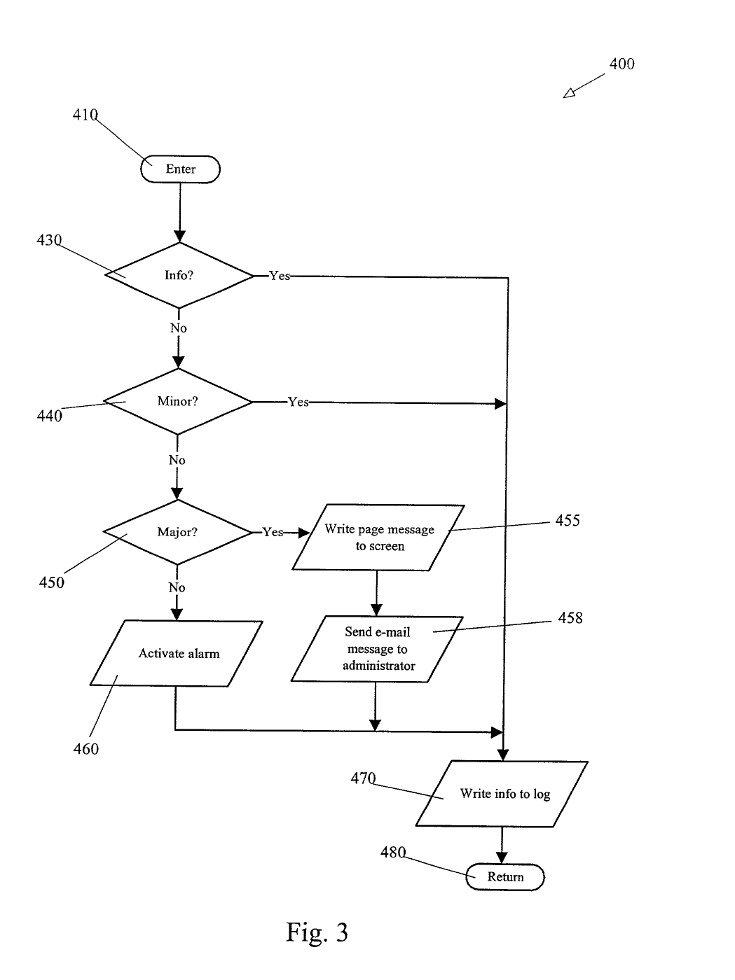

Another aspect of the method of the present invention is the initiation and functioning of the Error Handling Routine 400 shown in FIG. 3. Error handling tasks of this module operate in the background such that as specific network errors occur, the system administrator is appropriately notified so that corrective action may be taken. Error Handling Routine 400 as initiated at startup is entered at step 410. As explained above, when errors are detected, they are classified by the respective detecting module.

The purpose of the Error Handling Routine is to properly track out-of-normal operating conditions and to provide information to system administrators without unnecessarily delaying or interrupting operations. Errors of different priorities are tracked and reported. For example, an error will be indicated by the method of the present invention where certain information that should be written is not written to the server log. It will be obvious to those of skill in the art that this informational type of error is not significant and thus there is no need to interrupt or delay operation of the system. However, other errors could be considered minor, major or critical, each requiring a different level of reporting and subsequent action by the system. By providing a prioritized error tracking and reaction scheme, the method of the present invention improves the overall efficiency of remote client device sessions by minimizing operational interruptions.

At step 430 a decision is made regarding the nature of the error as classified and reported by the detecting module. If the error is informational only, the data is written to the error log at step 470 and flow returns to the main process via step 480. An example of an informational error would be failure of the BSL 183 to collect network data for a predetermined period of time. This failure would be written to the error log as informational only. However, should the situation persist, the continued inability to gather the data would escalate to minor, then major and finally critical, with the process following the appropriate response for each of these levels of error.

If the error is not informational, flow transfers to step 440 for a determination as to whether the error is minor in nature. If it is minor, the error log is updated at step 470 and flow returns via step 480 as described above. If the error at step 440 was not minor, a decision is made as to whether the error is major at step 450. If it is minor, the Yes path is followed and a message is written to a monitor screen at step 455 for interpretation by a system administrator. At step 458 an e-mail message is generated and sent to the system administrator as an additional notification method. If the decision at step 450 returns a No, the error must be critical, requiring immediate action, thus at step 460 an alarm is activated to notify the system administrator that such a critical error has occurred. The error log is then updated at step 470 and flow returns via step 480. In the preceding way, the method of the present invention categorizes errors into informational, minor, major and critical and provides an escalating handling method for responding to these errors which maximizes the uptime of the system.

The Internet is only one possible network topology that provides services to multiple users. Thus the invention discussed in detail above can apply to a wide variety of network architectures including, but not limited to, local area networks (LANs), wide area networks (WANs), intranets and internets. Further, data communications encompass a variety of data forms including, but not limited to, voice, video, audio, e-mail and software. While the discussion herein above centers on general data communications over the Internet, this should not be read as a limitation on the scope of the invention.

What is claimed is:

1. A method for providing dynamic determination of an optimum path from a remote client terminal to one of a plurality of mirrored content servers in a network, comprising:
monitoring the network to determine parameters representative of network performance;
receiving a request for content residing in said mirrored content servers from the remote client terminal;
resolving said request to a first returned content server IP address based on a default parameter;
analyzing said first returned address for compliance with a predetermined control logic based on predetermined parameters including said parameters representative of network performance, and hops between said servers and the remote client terminal;
repeating said resolving and analyzing with subsequently returned IP addresses as necessary to comply with said control logic; and
returning to said router a content server IP address complying with said control logic.

2. The method of claim 1, wherein said parameters representative of network performance comprise server load, network pipe load and server status.

3. The method of claim 2, wherein said predetermined parameters further include non-network performance parameters.

4. The method of claim 2, wherein said predetermined control logic comprises selecting one said parameter as the default parameter for identifying the first returned IP address and examining other parameters associated with said first returned IP address for compliance with threshold values.

5. The method of claim 4, wherein said default parameter is hops between the client terminal and a content server.

6. The method of claim 4, wherein said default parameter is server load.

7. The method of claim 4, wherein said default parameter is network pipe load.

8. The method of claim 1, wherein said receiving comprises:
monitoring a port for incoming requests containing IP addresses using a client request handler memory module; and
responding to the presence of an IP address request at the port by calling a best server locator memory module.

9. The method of claim 8, wherein said resolving comprises:
receiving in the best server locator module an anycast address from the client request handler module;
comparing said received anycast address from said client request handler module to a list of mirrored content server sites assigned to said received anycast address;
determining within the best server locator module if addresses stored therein match the anycast address received from a client request handler; and
selecting, upon finding a match, a mirrored content server having the least hops to the remote client terminal.

10. The method of claim 1, wherein said analyzing comprises:
determining within a best server locator module if the IP address for a mirrored content server returned by said best server locator module requires a static IP redirect, and if required, returning a corresponding static redirect IP address to the remote client terminal, otherwise;
performing a server load limit check of said mirrored content server represented by said returned IP address, returning said actual IP address of said mirrored content server to said remote client terminal unless said server load limit check requires selection of an alternate mirrored content server;
selecting said alternate mirrored content server if required by said server load limit check; and
returning the IP address of said alternate mirrored content server to said remote client terminal.

11. An apparatus for determining a path from a remote client to one of a plurality of mirrored content servers in a network, said apparatus comprising a processor communicating with a memory, wherein said memory comprises modules executable by the processor, including:
a best server locator module reading predetermined parameters including at least parameters indicative of network performance and hops between content servers and client terminal, and returning a server IP address complying with a predetermined control logic based on said predetermined parameters in response to a client content request; and
a client request handler module receiving requests from and forwarding responses to remote client terminals, said client request handler module communicating with the best server locator module.

12. The apparatus according to claim 11, wherein said memory further includes modules receiving network performance parameter updates and modifying data structures read by said best server locator module based on said updates.

13. The apparatus according to claim 12, wherein said modules receiving network performance updates comprise:
a server load detector module detecting server load at said mirrored content sites;
a pipe load detector module detecting pipe load at network routers; and
a server status monitor module detecting operational status of said mirrored content servers.

14. A method for providing dynamic determination of an optimum path from a remote client terminal to one of a plurality of mirrored content servers, comprising:
monitoring the status of a plurality of mirrored content servers sharing a same anycast address;
receiving a request from a remote client terminal, said request containing said anycast address;
comparing said received anycast address to a plurality of stored anycast addresses;
matching said received anycast address to one of the said plurality of stored anycast addresses wherein said matched anycast address is associated to a physical IP address representing a least hops path from said remote client terminal to one of the plurality of said mirrored content sites;
analyzing the current status of said matched mirrored content site; and
returning said physical IP address of said matched mirrored content site to said remote client terminal.

15. The method of claim 14, wherein said receiving comprises:
monitoring port 80 of a receiving device for incoming requests containing anycast addresses using a client request handler module, and;
responding to the presence of an anycast address on said port 80 by calling a best server locator module.

16. The method of claim 1, wherein said comparing comprises:
receiving in a best server locator module an anycast address from a client request handler module; and
comparing said received anycast address from said client request handler module to a list of mirrored content server sites assigned to said received anycast address.

17. The method of claim 14, wherein said matching comprises:
determining within a best server locator module if one of the said plurality of anycast addresses stored therein matches an anycast address received from a client request handler; and
selecting, upon finding a match, a mirrored content server having the least hops to the remote client terminal;

18. The method of claim 1, wherein said analyzing comprises:
determining if said physical IP address for a mirrored content server returned by a best server locator module requires a static IP redirect and, if required, returning a corresponding redirect static IP address to the remote client terminal, otherwise;
performing a server load limit check of said mirrored content server represented by said returned physical IP address, returning said actual IP address of said mirrored content server to said remote client terminal unless said server load limit check requires selection of an alternate mirrored content server; and
selecting said alternate mirrored content server if required by said server load limit check.

19. The method of claim 18, wherein said server load limit check further comprises:
checking the status of the mirrored content server;
determining the data load on said mirrored content server;
determining the data load on the data pipe used by said mirrored content server; and
returning a check OK status unless an error is detected causing the client request handler module to execute an error handling routine.

20. The method of claim 14, wherein said monitoring comprises:
checking for occurrence of errors on a continuous basis;
analyzing said occurrence of said errors;
placing said errors into one of a plurality of error categories;
responding to said categorized errors in one of a plurality of ways depending upon the severity of said categorized errors; and
reporting said errors to a log.
